(19) United States
(12) Patent Application Publication
(10) Pub. No.: US 2023/0058396 A1
(43) Pub. Date: Feb. 23, 2023

(54) THERMAL RUNAWAY BARRIER FOR A RECHARGEABLE ELECTRICAL ENERGY STORAGE SYSTEM

(71) Applicant: 3M INNOVATIVE PROPERTIES COMPANY, St. Paul, MN (US)

(72) Inventors: Peter T. DIETZ, Eagan, MN (US); Anne N. DE ROVERE, Woodbury, MN (US); Mark A. FAIRBANKS, Lino Lakes, MN (US); Bhaskara R. BODDAKAYALA, Troy, MI (US); Daniel S. BATES, Chisago City, MN (US); Sean M. LUOPA, Minneapolis, MN (US); Bradon A. BARTLING, Woodbury, MN (US); Kerstin C. ROSEN, Koln (DE); Claus H.G. MIDDENDORF, Neuss (DE); Christoph KUESTERS, Korschenbroich (DE); Jan Thomas KRAPP, Dusseldorf (DE)

(21) Appl. No.: 17/758,723

(22) PCT Filed: Jan. 15, 2021
(86) PCT No.: PCT/IB2021/050304

§ 371 Date: Jul. 13, 2022

Related U.S. Application Data
(60) Provisional application No. 62/961,410, filed on Jan. 15, 2020.

(51) Int. Cl. H01M 10/658; B32B 27/20; B32B 5/18; B32B 9/04; B32B 27/40

(52) U.S. Cl. CPC H01M 10/658; B32B 27/20; B32B 5/18; B32B 9/046; B32B 27/40; H01M 2220/20; B32B 2307/732; B32B 2262/101; B32B 2266/0278; B32B 2307/304; B32B 2457/10; B32B 2307/3065

(57) ABSTRACT

A thermal barrier article comprising a core layer containing a plurality of fibers or a flame-retardant foam, and a supplementary layer disposed on or integrated within the core layer, where the thermal barrier article is operatively adapted to survive or withstand at least one cycle of the Torch and Grit Test.

### FIELD

The invention relates to the use of a multilayer material as a thermal insulation barrier in a rechargeable electrical energy storage system comprising for example a plurality of single rechargeable battery cells or battery cell packs.

The present invention relates to electric vehicle battery modules and particularly to blast and thermally resistant barrier articles for managing battery module thermal runaway incidents. Test methods are also described. The provided articles can be especially useful, for example, in automotive and stationary energy storage applications.

### BACKGROUND

Rechargeable or reloadable batteries or rechargeable electrical energy storage systems comprising a number of single battery cells, such as for example lithium-ion cells, are known and used in several fields of technique, including e. g. as electric power supply of mobile phones and portable computers or electric cars or vehicles or hybrid cars.

It is also known, that particularly rechargeable battery cells, such as lithium-ion cells, sometimes undergo internal overheating caused by events such as short circuits within the cell, improper cell use, manufacturing defects or exposure to extreme external temperature. This internal overheating can lead to a so called “thermal runaway” when the reaction rate within the cell caused by the high temperature increases to a point where more heat is generated within the cell than can be withdrawn and the generated heat leads to a further increase of the reaction rate and in turn of the generated heat. In lithium-ion (Li-ion) batteries, for example, the heat generated within such defective cells can reach 500° C. to 1000° C., in localized hot spots even more.

In particular, it is essential in such cases to interrupt or at least reduce a heat transfer from defective cells or cell packs to other parts of the storage system or around the storage system, because the heat generated in a defective battery cell or cell pack can spread out to the neighboring cells, which in turn can cause overheat and then undergo thermal runaway. Also, it is important to limit the heat transfer to parts around the storage system, which may get destroyed or harmed when treated with the above-mentioned temperatures, causing electrical shortages which in turn could lead to unwanted effects as further cells getting into a thermal runaway.

It is accordingly usual to provide safety precautions for protecting the environment of overheated battery cells or packs of battery cells against the generated heat, including, in particular, not yet affected battery cells or packs but also surrounding construction elements of the system or device or apparatus containing the battery cells.

For this purpose, it has e. g. been suggested to insert thermally insulating barrier elements inside of a storage system in order to prevent or reduce the heat transfer from an overheated battery cell or pack of battery cells to other battery cells or cell packs of batteries and/or to the environment of the storage system.

This is for example described in U.S. Publication No. 2006/0164795 (Jones et al.) or U.S. Pat. No. 8,541,126 (Hermann et al.). According to these prior art documents, the thermal barrier elements can e. g. consist of a ceramic material such as aluminum oxide, magnesium oxide, silicon dioxide, calcium silicates, calcium magnesium silicates or alumina silicates, which materials provide high melting temperatures of about 500° C. to about 1500° C. and more, i. e. well above the temperatures normally achieved even short time during a thermal runaway event in a battery, combined with a relatively low thermal conductivity, such as a thermal conductivity less than 50 W/m K (measured at 25° C.). Such ceramic elements can e. g. consist of plates produced by compressing a number of laminates of said ceramic materials impregnated with a resin of suitable temperature resistance.

In the EP 3 142 166 A1 it has been disclosed a compressible composite material useful in particular as thermally insulating barrier element for batteries, which is a layered assembly of substantially rigid plates and compressible layers, which are alternately piled in direction vertical to their larges surface.

According to the Global Technical Regulation No. 20 which is the “Technical Regulation on the Electric Vehicle Safety (EVS)” of the United Nations, established in the global registry on Mar. 14, 2018, the following will be required for future vehicles:

In order to ensure the overall safety of vehicles equipped with a rechargeable electrical energy storage system (REESS) containing flammable electrolyte, the vehicle occupants should not be exposed to the hazardous environment resulting from a thermal propagation (which is triggered by a single cell thermal runaway due to an internal short circuit). First goal is to suppress thermal propagation completely. If thermal propagation cannot completely be suppressed, it is requested that no external fire or explosion occurs, and no smoke enters the passenger cabin within 5 minutes after the warning of a thermal event.

A housing for a rechargeable energy storage system may for example be made out of aluminum or an organic polymer sheet molded compound. Both can be damaged as soon as temperatures of 600° C. and above are reached. Even steel casings may be at risk in certain situations such as for example a deformation of the casing due to an accident or a malfunctioning of an electrical insulation material. There is a risk that heat, and gas gets out of the housing as soon as there is a thermal runaway event within the housing that reaches temperatures that are higher than 600° C.

In order to be able to test, if products fulfil the above-mentioned requirements, several test methods have been developed, one of them is the so-called nail penetration test.

A further trend is to be noticed, especially in the automotive industry, which is that the rechargeable electrical energy storage systems are getting bigger and bigger and the energy density higher and higher in order to be able to carry more energy, which helps to extend the range a vehicle can drive with a fully charged storage system without recharging the storage system. If such bigger storage systems get defective, the following reactions might also get more intense, because of the higher energy stored in those systems. This might lead to higher temperatures.

Rechargeable batteries including Nickel Metal Hydride or Lithium-Ion (Li-Ion) are used in electric vehicles to store energy and to provide power. The flow of current either into the battery during recharge or out of the battery into the vehicle and its accessories generates heat, which needs to be managed/dissipated proportional to the square of the current multiplied by the internal resistance of the battery cells and interconnected systems. A higher current flow implies a more intensified heating effect.

Li-Ion batteries perform optimally within a specific operating temperature range. If operation occurs outside the bounds of the specified range, then damage or accelerated degradation of the cells within the battery occurs. Thus, the battery may also need to be cooled or heated depending upon environmental conditions. This, in turn, drives the need to effectively manage thermal aspects of the battery before and during use and recharge.

Electrical vehicle battery modules comprise hundreds of cells that may be stored in pouches connected to one another in packs through various electrical connections (i.e. busbars). A catastrophic phenomenon called thermal runaway propagation occurs when one cell in a battery module catches on fire because it is punctured, damaged, or faulty in its operation. The resulting fire spreads to neighboring cells and then to cells throughout the entire battery in a chain reaction. These fires can be potentially massive, especially in high power devices such as electric vehicles, where it is common to see battery packs containing tens, hundreds, or even thousands, of individual cells. Such fires are not limited to the battery and can spread to surrounding structures and endanger occupants of the vehicle or other structures in which these batteries are located.

When thermal runaway occurs in a cell, it is also desirable for a thermal management system to block and/or contain ejected debris if a cell suddenly explodes. In electric vehicle applications, it is also important to protect occupants from the heat generated by the fire, thereby allowing enough time to stop the vehicle and escape.

Severe risks posed by thermal runaway propagation requires design of the battery module that features blast and thermally insulating barriers to mitigate the effects of such a thermal runaway and provide time for vehicle occupants to safety vacate in the event of a fire.

### SUMMARY OF THE INVENTION

In view of the above, there is still a need to provide suitable materials and suitable arrangements that help preventing or delaying thermal propagation within a rechargeable electrical energy storage system as well as heat transfer to parts around or outside of a rechargeable electrical energy storage system, which may get destroyed or harmed when treated with the above-mentioned conditions and temperatures. There is also a need for such suitable materials that are easy to use in an assembly process and provide flexibility with designing rechargeable electrical energy storage systems.

The present invention provides now the use of a multilayer material as a thermal insulation barrier in a rechargeable electrical energy storage system, with the multilayer material comprising at least one inorganic fabric, as well as at least one layer comprising inorganic particles or inorganic fibers or a combination thereof.

In another aspect, present invention provides a rechargeable electrical energy storage system with at least one battery cell and a multilayer material, with the multilayer material being used as a thermal insulation barrier. The multilayer material comprises at least one inorganic fabric, as well as at least one layer comprising inorganic particles or inorganic fibers or a combination thereof.

Protecting against the dangers associated with a sudden thermal runaway event in an electric vehicle battery is a significant technical challenge. One problem in devising a universal solution is that materials that work well in protecting against one aspect of thermal runaway fall short in other ways. For example, non-woven webs of polymeric fibers and foams can display excellent thermal insulation properties, but common polymers tend to be flammable or the fibers and foams are coated with encapsulant materials that are flammable. Heat shield materials made from woven non-combustible fibers (e.g., inorganic fibers) can be effective in preventing penetration of a fire but tend to be too thin to adequately insulate against the intense heat of a fire or to absorb/deflect debris that is launched when a cell explodes. Using thicker layers of heat shield materials is generally not cost effective. Combinations of these materials could work, but it can be difficult to bond these materials to each other, particularly when the selection of bonding materials may be constrained by flammability issues.

Another technical difficulty arises when using fibers and foams used in conventional thermal management systems. Even fire-resistant fibers and foams are prone to melting at sufficiently high temperatures. For example, greater than 600° C. (1112° F.). Fibers and foams that would not melt during such thermal runaway events (e.g., oxidized polyacrylonitrile) tend to be relatively brittle and can introduce new problems associated with fiber shedding or loose material during product manufacture, intermediate handling, and use. Such fibers do not bind to each other within a fibrous web and thus alternative ways must be devised to secure these fibers, so they do not escape and contaminate other battery components and spaces surrounding the battery.

Current test methods insufficiently determine how a material alone or in combination with other materials may be effectively used as barriers in electric vehicle compartments to provide blast and thermal resistance protection. Also, current test methods use the actual battery components including cells and modules, which is expensive and time consuming.

The present invention addresses these issues by providing a blast and thermal resistant barrier article that combines a core layer containing a plurality of fibers or a flame-retardant foam and a supplementary layer disposed on or integrated within the core layer. The core and supplementary layers create a blast and thermal barrier article is operatively adapted to survive or withstand at least one cycle of the Torch and Grit Test. In electric vehicle battery applications, the combination of the designated core and supplementary layers can provide blast protection, structural integrity and a high degree of thermal insulation in the event of fire exposure.

In one aspect of the present invention, a thermal barrier article is provided comprising a core layer containing a plurality of fibers or a flame-retardant foam and a supplementary layer disposed on or integrated within the core layer wherein the thermal barrier article is operatively adapted to survive or withstand at least one cycle of the Torch and Grit Test.

In another aspect of the present invention, a lithium ion battery compartment is provided comprising a thermal barrier article comprising a core layer containing a plurality of fibers or a flame-retardant foam and a supplementary layer disposed on or integrated within the core layer wherein the thermal barrier article is operatively adapted to survive or withstand at least one cycle of the Torch and Grit Test.

### BRIEF DESCRIPTION OF THE DRAWINGS

The invention will now be described in more detail with reference to the following figures exemplifying particular embodiments of the invention:

FIG. 1 is a cross-sectional view of a multilayer material according to the invention;

FIG. 2 is a schematic drawing of a rechargeable electrical energy storage system (REESS);

FIG. 3 is a side cross-sectional view of a blast and thermally resistant barrier article according to one embodiment of the present invention;

FIG. 4 is a side cross-sectional view of a blast and thermally resistant barrier article attached to a surface intended to be protected according to one embodiment of the present invention;

FIG. 5 is an illustration of a setup for a method to test the blast and thermally resistant barrier articles of the present invention; and

FIG. 6 is an illustration of exemplary thermocouple (TC) locations on the backside of the sample mounting steel (e.g., galvanized or stainless steel) sheet plate.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### Definition(s)

As used herein:

“thickness” means the distance between opposing sides of a layer or multilayer barrier article.

### DETAILED DESCRIPTION

As used herein, the term “operatively adapted” refers to a structure that is designed, configured and/or dimensioned to perform the identified operation or performance.

As used herein, the terms “preferred” and “preferably” refer to embodiments described herein that can afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises”, and variations thereof, do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, and vertical may be used herein and, if so, are from the perspective observed in the particular figure. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention.

The multilayer material according to the invention may for example be used to ensure the overall safety of vehicles equipped with a rechargeable electrical energy storage system. The multilayer material may comprise two layers, but it may also, depending on the application, comprise more than two layers of the above-mentioned materials.

A thermal runaway of prismatic Li-ion cells can basically be separated into 3 phases:
1. explosive venting when bust plate opens (6 to 8 bar for a 120 Ah prismatic cell), the immediate temperature increases to about 700° C.;
2. high pressure jet gas venting and particle blow out at high temperature (typically 600 to 700° C. for about 30 to 50 sec);
3. quiet gas venting/luminous flame.

Thus, a suitable material used as a thermal insulation barrier to prevent thermal propagation needs to withstand high temperatures and high pressures accompanied by gas venting and particle blow without getting too damaged. In addition, the material needs to provide thermal and electrical insulation properties even during and after the high temperature, pressure and gas and/or particle impact.

The multilayer material according to the invention may be flexible. Flexibility of the multilayer material enables a broader use of the material and a more effective application of the material, because the flexibility allows bending of the material and therefore more options of applying it in one or the other way within a rechargeable electrical energy storage system. The multilayer material according to the invention may also be compressible. Compressibility also allows a broader use and more effective application.

For example, the material may be compressible such that the total thickness of the multilayer material is ⅓ less in the compressed state compared to an uncompressed state. If the multilayer material is for example 6 mm thickness in an uncompressed state it should be compressible down to 4 mm in a compressed state.

The multilayer material according to the invention may comprise an inorganic fabric which comprises E-glass fibers, R-glass fibers, ECR-glass fibers, C-glass fibers, AR-glass fibers, basalt fibers, ceramic fibers, silicate fibers, steel filaments or a combination thereof. The fibers may be chemically treated. The inorganic fabric may for example be a cloth, a knitted fabric, a stitch bonded fabric, a crocheted fabric, an interlaced fabric or a combination thereof.

The multilayer material according to the invention may also comprise at least one layer comprising inorganic particles or inorganic fibers or a combination thereof. The inorganic fibers of the at least one layer comprising inorganic particles or inorganic fibers may be selected from the group of E-glass fibers, S-glass fibers, R-glass fibers, ECR-glass fibers, C-glass fibers, AR-glass fibers, basalt fibers, ceramic fibers, polycrystalline fibers, non-bio-persistent fibers, alumina fibers, silica fibers, carbon fibers, silicon carbide fibers, boron silicate fibers or a combination thereof. Non-bio-persistent fibers may for example be alkaline earth silicate fibers. More specific, the fibrous material may include annealed melt-formed ceramic fibers, sol-gel formed ceramic fibers, polycrystalline ceramic fibers, alumina-silica fibers, glass fibers, including annealed glass fibers or non-bio-persistent fibers. Other fibers are possible as well, if they withstand the high temperatures generated in a thermal event of a Li-ion battery.

In some embodiments, the inorganic particles may include, but are not limited to, glass bubbles, kaolin clay, talc, mica, calcium carbonate, wollastonite, montmorillonite, smectite, bentonite, illite, chlorite, sepiolite, attapulgite, halloysite, laponite, rectorite, perlite, and combinations thereof, preferably a particulate filler mixture comprises at least two of glass bubbles, kaolin clay, talc, mica, and calcium carbonate. Suitable types of kaolin clay include, but are not limited to, water-washed kaolin clay; delaminated kaolin clay; calcined kaolin clay; and surface-treated kaolin clay. In a preferred embodiment, inorganic particulate filler comprises glass bubbles, kaolin clay, mica and mixtures thereof. Optionally, an endothermic filler, such as alumina trihydrate, can be added. The at least one layer comprising inorganic particles or inorganic fibers may comprise an inorganic paper or an inorganic board. The layer may for example comprise an inorganic insulating paper comprising glass fibers and microfibers, such as 3M CEQUIN, commercially available from 3M Company, St. Paul, Minn., USA.

The inorganic fabric may for example comprise a thickness in the range of 0.4 to 3 mm, for example 0.4 to 1.5 mm. It may also comprise a weight of above 400 g/m² (gsm).

The at least one layer comprising inorganic particles or inorganic fibers may further comprise intumescent material. Useful intumescent materials for use in the multilayer material according to the invention include, but are not limited to, unexpanded vermiculite ore, treated unexpanded vermiculite ore, partially dehydrated vermiculite ore, expandable graphite, mixtures of expandable graphite with treated or untreated unexpanded vermiculite ore, processed expandable sodium silicate, for example EXPANTROL insoluble sodium silicate, commercially available from 3M Company, St. Paul, Minn., USA, and mixtures thereof.

The at least one layer comprising inorganic particles or inorganic fibers may comprise a thickness in the range of 0.1 to 20 mm. In some applications where thinner materials are used, the at least one layer comprising inorganic particles or inorganic fibers may comprise a thickness in the range of 0.2 to 4.0 mm, preferably 0.2 to 2.0 mm. The at least one layer comprising inorganic particles or inorganic fibers may comprise a weight in the range of 100 to 2500 g/m², for example 100 to 2000 g/m².

The multilayer material according to the invention may comprise at least one scrim layer. The scrim layer may be used to improve handling of the multilayer material by preventing fibers and/or particles from shedding out of the multilayer material. The scrim layer may comprise PET, PE, Melamine, inorganic material, such as for example E-glass. It may also or as an alternative comprise an inorganic or organic coating. The scrim layer may also comprise any other suitable material. It may be arranged next to the at least one layer comprising inorganic particles or fibers. It may also encapsulate the entire multilayer material according to the invention.

The total thickness of the multilayer material may be between 0.5 and 23 mm. In some applications where thinner materials are used, the total thickness of the multilayer material between 0.7 and 5 mm. It is possible to adjust the thickness of the material depending on the application the material is used in. As already stated above, the material may be flexible to improve the ease of applying the material in an assembly process. The material may also be compressible in order to improve the ease of applying the material in an assembly process.

The multilayer material may comprise a layer of organic or inorganic adhesive between the at least on inorganic fabric and the at least one layer comprising inorganic particles or inorganic fibers. The adhesive may be organic or inorganic. The adhesive may already be included either in the inorganic fabric or in the layer comprising inorganic particles or inorganic fibers. If a scrim is used in the multilayer material, the multilayer material may also comprise an adhesive between the multilayer material and a scrim. The adhesive may be organic or inorganic. It may already be included either in the scrim itself or in any of the materials used for the multilayer material.

Exemplary organic adhesives can be acrylic-based adhesives, epoxy-based adhesives, or silicone-based adhesives. The organic adhesives can be insulating adhesives, thermally conductive adhesives, flame retardant adhesives, electrically conducting adhesives, or an adhesive having a combination of conductive and flame-retardant properties. The exemplary organic adhesives used in the lamination can be contact adhesives, pressure sensitive (PSA) adhesives, B-stageable adhesives or structural adhesives. In an exemplary aspect an acrylic PSA can be used to bond together the functional layers of the thermal barrier composite material.

Exemplary inorganic adhesives can be selected from sodium silicate, lithium silicate, potassium silicate or a combination thereof.

The organic or organic adhesives can be directly coated onto one of the functional layers and optionally dried or can be preformed into freestanding lamination film adhesives that can be applied to the surface of one of the functional layers prior to contacting the next functional layers. In an alternative aspect, one or more of the functional layers can be in the form of a tape having an adhesive layer (e.g. a pressure sensitive adhesive layer) already disposed on the functional material.

The invention also relates to a rechargeable electrical energy storage system with at least one battery cell and a multilayer material, the multilayer material being used as a thermal insulation barrier and comprises:

at least one inorganic fabric, as well as

at least one layer comprising inorganic particles or inorganic fibers or a combination thereof.

The multilayer material according to the invention may for example be used to ensure the overall safety of vehicles equipped with a rechargeable electrical energy storage system.

The multilayer material may be arranged in a rechargeable electrically energy storage system such that the inorganic fabric faces the at least one battery cell or battery cell packs. The inorganic fabric is selected such that it has a high resistance towards temperature and other impacts, as they might occur during a thermal runaway event. A high sand blast resistance and/or a high tensile strength may be indicators for such a high overall resistance. If the inorganic fabric faces the at least one battery cell or battery cell pack, the fabric may withstand the main phases of a thermal runaway event, which are described above as:
1. explosive venting when burst plate opens (6 to 8 bar for a 120 Ah prismatic cell), the immediate temperature increases to about 700° C.
2. high pressure jet gas venting and particle blow out at high temperature (typically 600 to 700° C. for about 30 to 50 sec)
3. quiet gas venting/luminous flame

The main function of the inorganic fabric in such a scenario is thus to prevent the other layers from the thermal and mechanical impact of those phases. The main function of the other layers in such a scenario is to provide a thermal insulation barrier, so that the high temperatures stay within the rechargeable electrical energy storage system, preferably within the defective cell and do not reach parts around the defective cell or even around the system. If the rechargeable electrical energy storage system is used in a vehicle the main purpose of the multilayer material according to the invention is to ensure the overall safety of vehicles equipped with a rechargeable electrical energy storage system.

The rechargeable electrical energy storage system according to the invention may provide a multilayer material which is positioned between the at least one battery cell and a lid of the storage system. The multilayer material may for example be fixed to the lid. Or it may be placed between the battery cells and the lid. The multilayer material may in such a position be used as a thermal insulation barrier for the lid or to protect the lid and any systems, components that are arranged adjacent to the lid. The multilayer material may also be used as thermal insulation barrier for adjacent battery cells or battery packs. It may also be used as a thermal insulation barrier for any electrical components around the battery cells or battery packs such as for example cables or bus bars. When the multilayer material provides in addition electrically insulating properties, short circuits for example due to deformation or other harm, e. g. heated electrical insulation around different battery systems, can also be prevented. Another possibility is to arrange the multilayer material such that it covers a burst plate of the at least one battery cell. Of course, the material can also be positioned such in a rechargeable electrical energy storage system that it fulfills all of the above-mentioned requirements. As already stated above, it might be advantages to position the multilayer material according to the invention such that the inorganic fabric faces towards the at least one battery cell.

Also, the use of the multilayer material according to the invention is not limited to the use in a specific kind of rechargeable electrical energy storage systems. It may for example be used in rechargeable electrical energy storage system comprising prismatic battery cells, pouch cells, or cylindrical cells.

Surprisingly it has been found that the use of a multilayer material described above effectively can be used that no external fire occurs within a rechargeable electrical energy storage system as well as heat transfer to parts around or outside of a rechargeable electrical energy storage system. As will be described in the example section below, tests have shown that a multilayer material according to the invention withstands the in the GTR 20 mentioned requirements.

Herein below various embodiments of the present invention are described and shown in the drawings wherein like elements are provided with the same reference numbers.

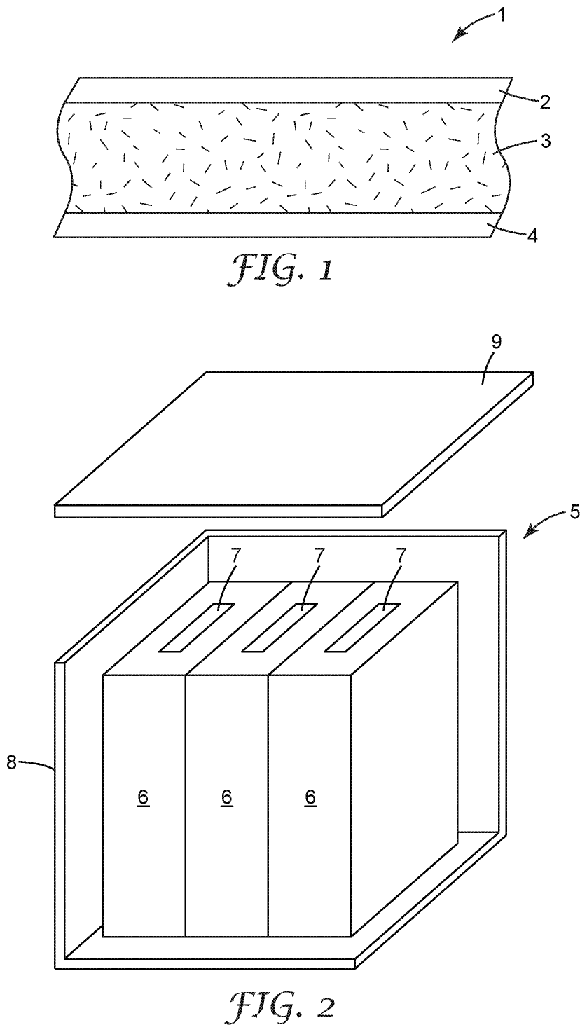

In FIG. 1 a cross-sectional view of a multilayer material 1 according to the invention is displayed. The multilayer material of FIG. 1 comprises an inorganic fabric layer 2 that is attached to a fiber mat 3 which is attached to a scrim layer 4. The scrim layer 4 and the fabric layer 2 are arranged on either side of the fiber mat 3. The layers 2, 3, 4 may for example be attached to each other through an adhesive.

FIG. 2 is a schematic drawing of a rechargeable electrical energy storage system (REESS) 5. The system comprises prismatic battery cells 6. The prismatic battery cells 6 each comprise a burst plate 7 to release potentially generated excessive pressure through a venting hole, for example in case of a thermal runaway event. The cells 6 are arrange in a housing 8 (which is shown with two open walls—one front wall and one side wall—that are closed in reality). The housing provides a lid 9.

As already described above regulations require that a rechargeable energy storage system is built in a way that no external fire occurs. One area that needs to be protected is the area above the burst plates 7. Parts of the system that are arranged over the burst plate need a thermal barrier in order to avoid a burn-through of the battery and open flames outside of the system. According to the invention the multilayer material 1 shown in FIG. 1 is placed on top of the battery cells 6 over their burst plates 7 under the lid 9 with the inorganic fabric layer 2 facing the battery cells (not shown).

The multilayer material 1 may also be placed between the cells 6 (not shown). Or it may be placed between the cells 6 and the side walls or the bottom wall of the housing 8 (not shown).

The blast and thermally resistant barrier articles described herein, in some embodiments, can be effective in mitigating the effects of thermal runaway propagation in Li-Ion batteries. These articles can also have potential uses in other commercial and industrial applications, such as automotive, residential, industrial, and aerospace applications, where it is necessary to protect people or surrounding structures from the effects of a flying debris or thermal fluctuations. For example, the provided blast and thermally resistant barrier articles can be incorporated into primary structures extending along or around transportation or building compartmental structures to protect users and occupants. Such applications can include protection around battery modules, fuel tanks, and any other enclosures or compartments.

The provided barrier articles generally include a core layer containing a plurality of fibers or a fire-retardant foam coupled to or with a supplementary layer. Optionally, the barrier article can include flame-retardant adhesive. These layers can be bonded to compartment walls or each other using a suitable binder. The components, configurations thereof, and test methods are described in the sub-sections that follow.

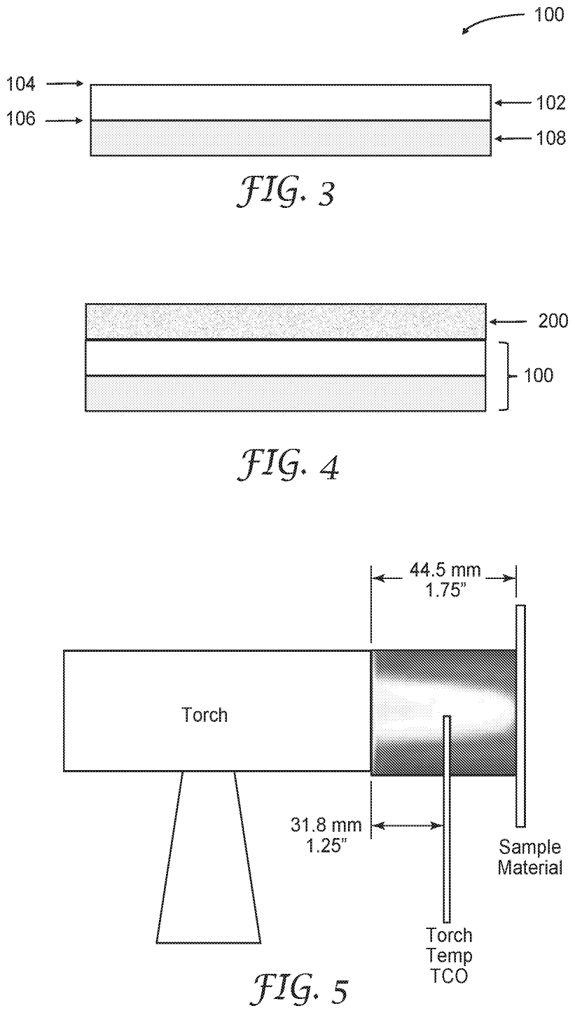

A blast and thermally resistant barrier article according to one embodiment is shown in FIG. 3 and hereinafter designated by the numeral 100. The barrier article 100 includes a core layer 102 having a plurality of fibers or a fire-retardant foam. The core layer 102 is generally made from one or more materials that produce a layer having a low thermal conductivity to reduce heat transfer when subjected to a thermal runaway event. Suitable core layers can be made from, for example, polycrystalline ceramic fiber, E-glass fiber, R-glass fiber, ECR-glass fiber, NEXTEL 312 fiber, basalt fiber, silicate fiber, melamine foam, or polyurethane foam. A plurality of fibers is typically entangled or point bonded to form a sheet or mat exhibiting a structure of individual fibers or filaments which are interlaid. Exemplary fiber mats used as the core layer 102 include MAFTEC blanket MLS-2 available from Mitsubishi Chemical Company of Tokyo, Japan. Other exemplary fiber mats used the core layer 102 include BONDO 488 and BONDO 499 fiberglass mats, CEQUIN insulating paper, or Dynatron 699 all commercially available from 3M Company of St. Paul, Minn., USA and nonwoven mats described in commonly owned U.S. Publication No. 2020/0002861(de Rovere et al) and U.S. Pat. No. 7,744,807 (Berrigan et a.). An exemplary foam used as the core layer is BASOTECT W commercially available from BASF Corporation of Ludwigshafen, Germany.

Particularly useful ceramic fibers for this application include ceramic oxide fibers that can be processed into fire-resistant mats. These materials can be made suitable for textiles by mixing small amounts of silica, boron oxides, or zirconium oxides into alumina to avoid formation of large crystalline grains, thereby reducing stiffness and increasing strength at ambient temperatures. Commercial examples of these fibers include filament products provided under the trade designation NEXTEL. These fibers can be converted into woven fibrous layers or webs that display both fire barrier properties and high strength.

Other useful materials that can be used in the thermal barrier article include ceramic fiber materials that combine alkaline earth silicate (AES) low biopersistent fibers, aluminosilicate ceramic fibers (RCF), and/or alumina silica fibers and vermiculite with an acrylic latex and other refractory materials to obtain a heat-resistant non-woven fibrous web, or mat. Examples of these are described, for example, in PCT Publication No. WO 2018/093624 (De Rovere, et al.) and U.S. Pat. No. 6,051,103 (Lager, et al.). In some cases, these fiber materials can be blended with endothermic flame-retardant additives such as aluminum trihydrate. Other additives can be, for example EXPANTROL (3M Company). These materials can be optionally intumescent, whereby the material swells up when heated to seal openings in the event of a fire. Examples of these ceramic fiber materials include products provided under the trade designation FYREWRAP by Unifrax I LLC, Tonawanda, N.Y.

Further, the core layer 102 can be made by combining both organic and inorganic fibers to form a fire-resistant fibrous felt. For example, fibers of silica, polyphenylene sulfide, and poly paraphenylene terephthalamide can be formed into a coated fabric. Some of these fabrics, available from TexTech Industries, Portland, Me., have been used as burn through insulation in aerospace applications.

Useful inorganic fibers can have very high melting temperatures to preserve the integrity of the fire barrier article when exposed to fire. High melting temperatures also help avoid softening or creep in the fire barrier material under operating conditions. Polycrystalline alumina-based fibers, for example, can have melting temperatures well in excess of 1400° C. The inorganic fibers can have a melting temperature in the range from 600° C. to 2000° C., from 800° C. to 2000° C., from 1100° C. to 1700° C., or in some embodiments, less than, equal to, or greater than 600° C., 650° C., 700° C., 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or 2000° C.

The core layer 102, with optional layers, of the blast and thermally resistant barrier directly contacts a surface 200, as represented in FIG. 4, such as a lid or compartmental wall of an electric vehicle battery.

Covering all or at least a functionally significant portion of, and directly contacting or integrated with, the core layer 102 on a second major surface 106 is a supplementary layer 108. The supplementary layer 108, like the core layer 102, is generally made from one or more materials that produce a layer having a low thermal conductivity to reduce heat transfer and has a high impact strength to withstand a blast when subjected to a thermal runaway event can be an aqueous mixture of inorganic binders containing inorganic filler particles. Specific properties of the supplementary layer 108 can also enhance or supplement the thermal and impact strength properties or the core layer 102. Suitable supplementary layers 108 can be made from, for example, inorganic insulating paper, ceramic fiber, E-glass fiber, R-glass fiber, ECR-glass fiber, basalt fiber, silicate fiber, aqueous mixtures of inorganic binder and particle, or any combination thereof.

The supplementary layer 108 can be applied as a continuous uninterrupted layer or it can be applied in discrete stripes that are applied laterally, longitudinally, or interwoven to produce square, diamond, or other patterns on the core layer 102.

The inorganic binder can comprise a mixture of water and inorganic binder particles, where the particles are either in suspension, have been dissolved, or some of the particles are in suspension and some have been dissolved. The inorganic binder is preferably a solution of inorganic colloidal particles (e.g., a colloidal solution of silica or alumina particles). The inorganic binder may also be a sodium silicate, potassium silicate, or lithium silicate solution, where the sodium silicate and the potassium silicate are mostly or completely dissolved. Sodium silicate and potassium silicate can be in powder form, which can be dissolved in water to form the solution, and they can be already dissolved in a water solution.

The inorganic filler particles are preferably particles of a clay such as, for example only, kaolin clay, bentonite clay, montmorillonite clay, or any combination thereof. The clay filler particles may also be in the form of a calcined clay, delaminated clay, water washed clay, surface treated clay, or any combination thereof. The inorganic filler particles may also be, alternatively or additionally, particles of elemental metal, metal alloy, precipitated silica, fume silica, ground silica, fumed alumina, alumina powder, talc, calcium carbonate, aluminum hydroxide, titanium dioxide, glass bubbles, silicon carbide, glass frit, calcium silicate, or any combination thereof. The inorganic filler particles may be any other fine particulate that completely, mostly or at least substantially retains the inorganic binder in the fabric without forming the mixture into a gel or otherwise coagulating, when mixed with the inorganic binder (especially inorganic colloidal binder particles) in the presence of water, such that the mixture becomes a solid mass that cannot be saturated/impregnated into the inorganic fiber fabric. It can be desirable for the inorganic filler particles to have a maximum size (i.e., major dimension) of up to about 100 microns, 90 microns, 80 microns, 70 microns, 60 microns or, preferably, up to about 50 microns.

Fabrics for forming thermal barrier articles include inorganic fibers (e.g., continuous glass fibers, silica fibers, basalt fibers, polycrystalline fibers, heat treated refractory ceramic fibers or any combination thereof,) suitable for being woven and/or knitted into a fabric. As used herein, a fabric refers to a woven fabric, knitted fabric, chopped strand mat, continuous strand mat, needled felt or a combination of any type of fabric. A fabric according to the present invention can be made from the same or different types of fibers. As discussed herein, the fabric of the thermal insulating blast resistant composite material is saturated, soaked, coated, sprayed or otherwise impregnated throughout all, most or at least substantial portion of its thickness with the aqueous mixture then dried. Acceptable basis weights of the inorganic fabrics range from about 200 to about 2000 grams per square meter (gsm). Surprisingly, e-glass fabric when used in can survive temperatures of 1200° C. or greater. This is surprising in the fact that e-glass has a recommended use temperature of just 620° C.

In some embodiments, it may be desirable for the aqueous mixture to further comprise dyes, pigment particles, IR reflecting pigment particles, biocides, thickening agents, pH modifiers, PH buffers, and surfactants etc.

The aqueous mixture used to impregnate the fabric is typically a slurry comprising water, an inorganic binder and inorganic filler particles. Although the weight percent of each component within the slurry may vary, typically a given slurry comprises from about 20.0 to about 54.0 percent by weight (pbw) of water, from about 1.0 to about 36.0 pbw of one or more inorganic binders, and from about 10.0 to about 70.0 pbw of inorganic filler particles, based on a total weight of the slurry. More typically, a given slurry comprises from about 22.0 to about 45.0 pbw of water, from about 5.0 to about 30.0 pbw of one or more inorganic binders, and from about 20.0 to about 60.0 pbw of inorganic filler particles, based on a total weight of the slurry.

Although the particle size of the inorganic binder material is not limited, typically, the inorganic binder comprises inorganic binder particles having a maximum particle size of about 200 nm, preferably a maximum particle size of about 100 nm. More typically, the inorganic binder comprises inorganic binder particles having a particle size ranging from about 1.0 to about 100 nm. Even more typically, the inorganic binder comprises inorganic binder particles having a particle size ranging from about 4.0 to about 60 nm.

Further, although the particle size of the inorganic filler particles is not limited, typically, the inorganic filler particles have a maximum particle size of about 100 microns (μm). More typically, the inorganic filler particles have a particle size ranging from about 0.1 μm to about 100 μm. Even more typically, the inorganic filler particles have a particle size ranging from about 0.2 μm to about 50 μm.

Additional layers for example Insulators can be positioned between the core layer 102 and external surface to improve thermal and blast performance. Insulators suitable for use in the present invention can be in the form of a nonwoven fibrous web, mat, scrim or strip. The insulator can include one or more layers and comprise any suitable commercially available ceramic fiber insulation. Without intending to be so limited, such insulators may comprise, for example, glass fibers, silica fibers, basalt fibers, refractory ceramic fibers, heat treated refractory ceramic fibers, polycrystalline fibers, high temperature biosoluble inorganic fibers, or aerogel-based insulators, etc., or any combination thereof, as desired. High-temperature adhesive may comprise a heat-resistant, dryable adhesive comprising a mixture of colloidal silica and clay, or a mixture of sodium or potassium silicate and clay. The adhesive may also contain delaminated vermiculite, fumed silica, fumed alumina, titanium dioxide, talc, or other finely ground metal oxide powders. The adhesive may further comprise one or more organic binders. Suitable organic binders include, but are not limited to, ethylene vinyl acetate (EVA), acrylic, urethane, silicone elastomers and/or silicone resins. One or more organic binders may be added to improve green strength or enhance water resistance of the adhesive. The dryable adhesive may also contain IR reflective pigments, glass or ceramic bubbles or micro-porous materials such as aerogels.

Exemplary aqueous mixtures of inorganic binder and particles are further described in commonly owned PCT Publication No. WO2013/044012 (Dietz). Other exemplary supplementary layers include CEQUIN insulating paper, BONDO 499, Dynatron 699, or Nextel 312 fiberglass cloths (all commercially available from 3M Company).

The supplementary layer 108 can be laid upon and adhere to the core layer 102 or can be spray coated if it is a mixture. As the core layer 102 is being assembled, the supplementary layer 108 may also be integrated or mixed with the core layer 102 to create a single layer.

One or more optional layers could be included within, or disposed on, a first surface 104 of the core layer 102. Such additional layers can include fire-retardant adhesive promoting coatings or sealants that enhance bonding and thermal conductivity across the barrier article 100 and/or barrier layers. The fire-retardant coating or sealant can be a water-based silicone elastomer. Examples include FIREDAM 200, Fire Barrier Watertight Sealant 3000WT, and Fire Barrier Silicone Sealant 2000+ each available from 3M Company. The coatings can be applied by spraying, painting, or the like in thicknesses of 1000 micrometers to 2000 micrometers. Optionally, a flame-retardant adhesive can be applied to the first major surface 104 and/or second major surface 106 of the core layer 102 to improve adherence to the supplementary layer 108 or surface 200 (FIG. 4) to which the barrier article is affixed. Exemplary flame-retardant adhesives include 9372W and Silicone 3000WT (available from 3M Company), and/or fire and water barrier tapes.

The blast and thermally resistant barrier article 100 can have any suitable thickness. Depending on the nature of the core layer 102 and/or other components in the barrier, the preferred thickness often reflects a balance amongst the factors of cost, web strength, and fire resistance. The barrier article can have an overall thickness in the range from 100 micrometers to 25000 micrometers, from 500 micrometers to 12500 micrometers, from 2000 micrometers to 5000 micrometers, or in some embodiments, less than, equal to, or greater than 100 micrometers, 200, 300, 400, 500, 600, 700, 800, 900, 1000, 1200, 1500, 1700, 2000, 2500, 3000, 3500, 4000, 4500, 5000, 6000, 7000, 8000, 9000, 10000, 12500, 15000, 17000, 20000, or 25000 micrometers.

These layers, and successive layers, are shown flatly contacting each other. However, it is to be understood that the layers of the barrier article 100 are flexible and the contacting areas between layers may not be planar or even continuous.

The barrier article 100 of FIG. 3 can be disposed in one or more locations in an electric vehicle battery module. Typically, a plurality of battery cells is structurally aligned and secured within a battery compartment. The battery cells can be any shape (e.g., cylindrical or rectangular) or size. Gaps are generally present between each of the battery cells and/or between the battery cells and the walls of the battery compartment. The barrier articles can be secured to the compartment lid or disposed on the walls of the battery compartment.

### EXEMPLARY EMBODIMENTS

### Use Embodiments

1. Use of a multilayer material as a thermal insulation barrier in a rechargeable electrical energy storage system, the multilayer material comprising:

at least one inorganic fabric, as well as

at least one layer comprising inorganic particles or inorganic fibers or a combination thereof.

2. Use of a multilayer material according to embodiment 1, wherein the inorganic fabric comprises E-glass fibers, R-glass fibers, ECR-glass fibers, basalt fibers, leached and ion-exchanged fibers, ceramic fibers, silicate fibers, steel filaments or a combination thereof.
3. Use of a multilayer material according to embodiment 1 or 2, wherein the at least one layer comprising inorganic particles or inorganic fibers, comprises E-glass fibers, S-glass fibers, R-glass fibers, ECR-glass fibers, basalt fibers, ceramic fibers, polycrystalline fibers, non-bio-persistent fibers, alumina fibers, silica fibers or a combination thereof.
4. Use of multilayer material according to embodiment 1 or 2, wherein the at least one layer comprising inorganic particles or fibers comprises an inorganic paper or an inorganic board.
5. Use of a multilayer material according to any of the preceding embodiments, wherein the inorganic fabric comprises a thickness in the range of from about 0.4 mm up to about 3 mm.
6. Use of a multilayer material according to embodiment 5, wherein the inorganic fabric comprises a thickness in the range of from about 0.4 mm up to about 1.5 mm.
7. Use of a multilayer material according to any of the preceding embodiments, wherein the inorganic fabric comprises a weight of above about 400 gsm.
8. Use of a multilayer material according to any of the preceding embodiments, wherein the at least one layer comprising inorganic particles or inorganic fibers further comprises intumescent material.
9. Use of a multilayer material according to any of the preceding embodiments, wherein the at least one layer comprising inorganic particles or inorganic fibers comprises a thickness in the range of from about 0.1 mm up to about 20 mm.
10. Use of a multilayer material according to any of the preceding embodiments, wherein the at least one layer comprising inorganic particles or inorganic fibers comprises a weight in the range of from about 100 gsm up to about 2500 gsm.
11. Use of a multilayer material according to embodiment 10, wherein the at least one layer comprising inorganic particles or inorganic fibers comprises a weight in the range of from about 100 gsm up to about 2000 gsm.
12. Use of a multilayer material according to any of the preceding embodiments, wherein the multilayer material comprises at least one scrim layer.
13. Use of a multilayer material according to any of the preceding embodiments, wherein the multilayer material comprises a total thickness in the range of from about 0.5 mm up to about 23 mm.
14. Use of a multilayer material according to any of the preceding embodiments, wherein the multilayer material comprises a layer of organic or inorganic adhesive between the at least one inorganic fabric and the at least one layer comprising inorganic particles or inorganic fibers.
15. Rechargeable electrical energy storage system with at least one battery cell and a multilayer material, the multilayer material being used as a thermal insulation barrier and comprises:

at least one inorganic fabric, as well as

at least one layer comprising inorganic particles or inorganic fibers or a combination thereof.

16. Rechargeable electrical energy storage system according to embodiment 15, wherein the multilayer material is arranged such in the system that the inorganic fabric faces the at least one battery cell.
17. Rechargeable electrical energy storage system according to any of the embodiments 15 or 16, wherein the multilayer material is positioned between the at least one battery cell and a lid of the storage system.
18. A thermal barrier article comprising:

a core layer containing a plurality of fibers or a flame-retardant foam; and

a supplementary layer disposed on or integrated within the core layer,

wherein the thermal barrier article is operatively adapted to survive or withstand at least one cycle of the Torch and Grit Test.

19. The thermal barrier article of embodiment 18, wherein the Torch and Grit Test includes at least one cycle comprising:

subjecting an exposed face of the thermal barrier article to an elevated temperature in the range of from about 600° C. up to about 1800° C., or from about 800° C. up to about 1400° C., for at least 5 seconds, and

while the exposed face is still subjected to the elevated temperature, subjecting the exposed face to a blasting of metal oxide particle media having a size in the range of from about 60 to about 200 grit (e.g., 80 or 120 grit) for at least 10 seconds, where the particle media is being discharged at a pressure in the range of from about 25 to about 50 psi.

20. The thermal barrier article of embodiment 19, wherein the exposed face is positioned about 44.5 mm (1.75 inches) from the source of the temperature.
21. The thermal barrier article of embodiment 19 or 20, wherein the exposed face is positioned about 44.5 mm (1.75 inches) from the source of the discharged particle media.
22. The thermal barrier article of any one of embodiments 19 to 21, wherein each cycle also comprises subjecting an exposed face of the thermal barrier article to a temperature in the range of from about 600° C. up to about 1800° C., or from about 800° C. up to about 1400° C., for at least 5 seconds, after the blasting.
23. The thermal barrier article of any one of embodiments 19 to 22, wherein the thermal barrier article is operatively adapted to survive or withstand in the range of 1 to 12 (i.e., 1, 2, 3, 4, 5, 6, 7, 8, 9, 10, 11 or 12) cycles of the Torch and Grit Test.
24. The thermal barrier article of any one of embodiments 19 to 22, wherein each cycle of the Torch and Grit Test is performed at multiple locations across the exposed face.
25. The thermal barrier article of any one of embodiments 19 to 22, wherein only one cycle of the Torch and Grit Test is performed at multiple locations across the exposed face.
26. The thermal barrier article of any one of embodiments 19 to 22, wherein each cycle of the Torch and Grit Test is performed only at a central location on the exposed face.
27. The thermal barrier article of any one of embodiments 19 to 22, wherein only one cycle of the Torch and Grit Test is performed only at a central location on the exposed face.
28. The thermal barrier article of any one of embodiments 19 to 27, wherein the plurality of fibers comprises polycrystalline ceramic fibers, E-glass fibers, R-glass fibers, ECR-glass fibers, basalt fibers, or silicate fibers.
29. The thermal barrier article of any one of embodiments 18 to 28, wherein the flame-retardant foam comprises melamine or polyurethane.
30 The thermal barrier article of any one of embodiments 18 to 29, wherein the supplementary layer comprises an inorganic binder coating containing inorganic particles.
31. The thermal barrier article of any one of embodiments 18 to 30, wherein the thermal barrier article has a thickness in the range of from about 0.5 mm to about 10.0 mm.
32. A battery compartment of an electric vehicle comprising at least one battery cell or assembly at least partially enclosed by the thermal barrier article of any one of embodiments 18 to 31.
33. The battery compartment of embodiment 32, wherein the battery cell or assembly is for powering an electric vehicle.
34. A method of arresting or at least slowing down the occurrence of a thermal runaway event in an electric vehicle battery assembly, with the method comprising:

at least partially enclosing at least one battery cell of an electric vehicle battery assembly with the thermal barrier article of any one of embodiments 18 to 31.

35. A method of evaluating whether a thermal barrier article can arrest or at least slow down the occurrence of a thermal runaway event in an electric vehicle battery assembly, where the method includes performing at least one cycle comprising:

subjecting an exposed face of the thermal barrier article to an elevated temperature in the range of from about 600° C. up to about 1800° C., or from about 800° C. up to about 1400° C., for at least 5 seconds, and

while the exposed face is still subjected to the elevated temperature, subjecting the exposed face to a blasting of metal oxide particle media having a size in the range of from about 60 to about 200 grit (e.g., 80 or 120 grit) for at least 10 seconds, where the particle media is being discharged at a pressure in the range of from about 25 to about 50 psi.

36. The method of embodiment 35, wherein the exposed face is positioned about 44.5 mm (1.75) inches from the source of the temperature.
37. The method of embodiment 35 or 36, wherein the exposed face is positioned about 44.5 mm (1.75 inches) from the source of the discharged particle media.
38. The method of any one of embodiments 35 to 37, wherein each cycle also comprises subjecting an exposed face of the thermal barrier article to a temperature in the range of from about 600° C. up to about 1800° C., or from about 800° C. up to about 1400° C., for at least 5 seconds, after the blasting.
39. The method of any one of embodiments 35 to 38, wherein the method comprises performing in the range of 1 to 12 (i.e., 1, 2, 3, 4, 5, 6, 7, 8, 9, 10, 11 or 12) cycles.
40. The method of any one of embodiments 35 to 39, wherein each cycle is performed at multiple locations across the exposed face.
41. The method of any one of embodiments 35 to 39, wherein only one cycle is performed at multiple locations across the exposed face.
42. The method of any one of embodiments 35 to 39, wherein each cycle is performed only at a central location on the exposed face.
43. The method of any one of embodiments 35 to 39, wherein only one cycle is performed only at a central location on the exposed face.

### EXAMPLES

TABLE 1
Test Materials

| Material | Description |
|---|---|
| INTERAM Mat | Nonwoven made from inorganic |
| | alkaline earth silicate fibers, |
| | commercially available from 3M |
| | Company, St. Paul, MN, USA |
| CEQUIN | Inorganic Insulation Paper, |
| | commercially available from |
| | 3M Company |
| AVSil ® 84CH | Silica Fabric commercially |
| | available from AVS Industries |
| | LLC, New Castle, DE, USA |
| TG 430 fabric/ | Coated glass fabric commercially |
| 9kk-CS | available from HKO Isolier-und |
| | Textiltechnik GmbH, Oberhausen, |
| | Germany |
| TW-600-13-100 | Basalt Fabric commercially |
| | available from Sudaglass Fiber |
| | Technology, Inc, Houston, |
| | TX, USA |
| Micashield | DM338S, Dupré Minerals Ltd, |
| DM338S | Stafforshire, England |
| Superwool Plus | Fibrous insulation material, Morgan |
| | Advanced Materials, Windsor, |
| | United Kingdom |

### Examples 1-6 (EX1-EX6) and Comparative Example 1 (CE1)

Sample constructions are represented in Table 2. The multilayer laminates of Examples 1-3 were prepared by spraying 3M Display Mount spray adhesive onto a fabric. A fiber mat was placed the fabric on top and then rolled with a 4.54 kg (10 lb) roller. Comparative Example 1 was coated with Micashield D338S by using a 3M Accuspray ONE Spray Gun system with atomizing head of 1.8 mm size. The sample was dried at 80° C. for 30 minutes. The mica layer had a dry weight of about 30 gsm.

The multilayer laminates of Examples 4-6 were prepared by using a #30 Mayer rod to draw down and apply a sodium silicate adhesive onto a CEQUIN paper material. The inorganic fabric layer was then placed on top and then rolled with a 4.54 kg (10 lb) roller. The multilayer laminate was then dried at 82° C. (180° F.) for five minutes. Example 5 had a total laminate thickness of about 0.95 mm and a total laminate basis weight of 1103 gsm. Example 6 had a total laminate thickness of about 0.94 mm and a total laminate basis weight of 1057 gsm. Comparative Example 1 had a total laminate thickness of about 1.23 mm and a total laminate basis weight of 1391 gsm. The samples were subjected to the tests identified in Table 3 and the results are also represented in Table 3.

TABLE 2
Sample Constructions

| Example | Inorganic fabric | Inorganic |
|---|---|---|
| Example 1 | Silicate fabric AVSil ® | INTERAM Mat |
| (EX1) | 84CH 6010 gsm, 0.76 mm | 800 gsm |
| Example 2 | TG 430 fabric 430 gsm, | INTERAM Mat |
| (EX2) | 0.44 mm | 400 gsm |
| Example 3 | TG 430 fabric 430 gsm, | CEQUIN I 15 mil |
| (EX3) | 0.44 mm | (0.38 mm, 410 gsm) |
| Example 4 | TW-600-13-100 fabric, | CEQUIN I 20 mil |
| (EX4) | 600 gsm, 0.55 mm | (0.51 mm, 540 gsm) |
| Example 5 | TG 430 fabric 430 gsm, | CEQUIN I 20 mil |
| (EX5) | 0.44 mm | (0.51 mm, 540 gsm) |
| Example 6 | 2 layers of TG 430 fabric | CEQUIN I 20 mil |
| (EX6) | 430 gsm, 0.44 mm | (051 mm, 540 gsm) |
| Comparative | Micashield DM338S | INTERAM Mat |
| Example 1 | | 800 gsm |
| (CE1) | | |

A thermal runaway of prismatic Li-ion cells can basically be separated into 3 phases:
1. explosive venting when bust plate opens (6 to 8 bar for am 120 Ah prismatic cell), immediate temperature increases to about 700° C.
2. high pressure jet gas venting and particle blow out at high temperature (typically 600 to 700° C. for about 30 to 50 sec)
3. quiet gas venting/luminous flame

### Nail-Penetration Test:

The nail-penetration test that was used for testing the multilayer material according to the invention was conducted as follows: The nail penetration test was done with a high capacity (120 Ah) prismatic Li-ion battery cell. One single Li-ion cell was covered on both sides with thermal insulating hard plaster FERMACEL, commercially available plates in order to keep the heat inside the cell. This sandwich construction (FERMACELL plate—battery cell—FERMACELL plate) was fixed in-between two strong steel plates to a massive workbench. A steel-nail—X15CrNiSi25-21 nail with a diameter of 5 mm—penetrates with a speed of 25 mm/min through a hole in the steel plate into the 100% charged cell.

The barrier material to be investigated was fixed at an aluminum plate in the dimension 200 by 200 by 1.5 mm. This plate was positioned above the top of the cell in a defined distance (12 mm and 20 mm). The efficiency of the barrier material was quantified by measuring the temperature with type K temperature sensors below and above the aluminum plate with the barrier material. Above the top side of the plate, a heat shield made of PERTINAX phenolic sheet was positioned in order to reduce the radiation from the back side and to avoid the heating by flames turning around.

When the nail penetrates the separator inside of the battery cell, an internal shortcut initiates a thermal runaway followed by temperature increase and decomposition of the electrolytes. After the pressure inside the cell exceeds a limit of several bars the burst plate brakes and hot gas of about 600 to 750° C. and particles are blown out under high pressure for about 45 to 60 s. For another 4 to 5 minutes the hot gas is released with reduced pressure.

### Sandblast Test:

For the sandblast test a commercially available sandblast cabinet was used. The sample material was mounted to a metal sheet of the dimension 100 by 50 mm. The sample of dimension 80 by 45 mm was fixed with a masking tape on all sides to the metal sheet. A fixture inside of the cabinet held the samples in a defined position in front of the nozzle. Compressed air was used to accelerate the sandblast media onto the target until the specimen was damaged in an area of 4+/−1 mm diameter. The sanding time (in seconds (s)) was a measure for the resistance of a sample against a particle loaded air. The sample material was either not heat treated or heat treated treated in a laboratory kiln (L24/11/P330 of Nabertherm GmBH of Lilienthal, Germany) at 700° C. for five minutes before testing. Sandblast test conditions were as follows: 65 mm sample distance to nozzle, 4 mm nozzle diameter, Type 211 glass beads with grain size 70-110 micrometers was used as the media and the angle of impact was between 90° and 100°.

### Tensile Test:

The tensile test methods of ISO 4606 and ASTM D-828 were used.

### Flame Tests:

The methods of UL94 HB flammability testing were followed. A sample passed the test if the material was not punctured.

For Examples 3 and 5, Torch Flame Test A was conducted using a Bernzomatic torch TS-4000 trigger equipped with a MAP Pro fuel cylinder that provides a flame temperature in air of 2054° C./3730° F. Test samples were mounted at a fixed distance of 2.75″ (7 cm) from the flame with a metal clip attached at the bottom of the sample to help stabilize the sample during the test and exposed to the flame for a continuous time period of 10 minutes. The temperature measured at the fixed distance of 2.75″ (7 cm) from the flame was approximately 1000° C.

An additional higher temperature Torch Flame Test B was conducted for Examples 5, 6, and 7 by testing the sample at the fixed distance of 1″ (2.54 cm) from the 2054° C./3730° F. flame.

### Constant Gap Thermal Barrier Test (CGTBT)

One side of a sample was exposed to a temperature of 600° C. Measurement probes (a Type K Nickel-alloy thermocouple) were connected to the other side of the sample to measure the temperature. Each sample was compressed to a constant gap of 1.6 mm, and the test was conducted for ten minutes. A ceramic mat (make/model) was tested and used as the control.

### Torch and Grit Test (T&GT)

Each sample was mounted to a either a 0.7 mm thick galvanized steel or stainless-steel sheet by VHB tape (3M Company). The sample was positioned 44.5 mm (1.75 inches) as represented in FIG. 5 from the nozzle of a Champion Bench hydrogen torch burner obtained from Bethlehem Apparatus Company Inc, of Hellertown, Pa., USA. A thermocouple (TCO) was positioned 31.8 mm (1.25 inches) from the nozzle of the burner and another was placed on the backside center of the steel sheet. A blaster gun was loaded with 120 grit aluminum oxide non-shaped media and aligned with the nozzle of the torch at the same distance (44.5 mm) from the sample. The torch of the Champion Bench Burner was adjusted to 1200° C. The media blaster gun was then triggered at 172.4 kPa (25 psi) or 344.7 kPa (50 psi). A sample was either: 1) exposed to 12 blast cycles each lasting 15 seconds with 10 seconds of active blast time and 5 seconds of inactive blast time at a target location or 2) exposed to 1 blast cycle lasting 20 seconds with 5 seconds of inactive blast time, followed by 10 seconds of active blast, and then 5 seconds of inactive blast time at three target locations spaced 38.1 mm (1.5 inches) apart. Sample testing was stopped if a hole caused by either burn through or the media blasts was visible in the layers of the barrier article

### Additional Description of Torch & Grit Test Procedure

### 1. Definition/Objective

This test procedure describes a method of evaluating the performance of materials by exposing them to a high temperature flame and pressurized grit blasts over a period of time.

### 2. Safety

2.1 Always use proper PPE for 3M labs. Safety glasses, dust mask, proper gloves for handling hot materials and flame-retardant lab coat.

### 3. Definitions and Terminology

3.1 T&GT—Torch & Grit Test

### 4. Sample Information and Preparation

4.1 Minimum sample size in the range of from 102 mm×102 mm (4″×4″) to 203 mm×254 mm (8″×10″)
4.2 Label testing side samples on top for identification purposes
4.3 Mount on steel (e.g., stainless steel) sheet back plate (e.g., 0.7 mm thick) using, e.g., 3M VHB tape or a clamping system so the sample rests on mounting screws and is held at the top
4.4 Take picture of sample prior to mounting or as mounted and ready to be tested
4.5 Document sample in test log

### 5. Test Equipment/Materials Needed

5.1 Bethlehem Champion Torch (listed as “Special 3M).
5.2 Hand held abrasive media blast gun with regulator, 120 grit aluminum oxide non shaped media.
5.3 Electric timer/solenoid assembly unit.
5.4 Hydrogen gas bottle, regulator, flashback arrestor, hose.
5.5 Oxygen gas bottle, regulator, flashback arrestor, hose.
5.6 Type B and Type K thermocouples (Type K Nickel-alloy thermocouples suitable for measurements less than or equal to temperatures of 1350° C. or Type B Platinum/rhodium-alloy thermocouples suitable for measurements less than or equal to temperatures of 1800° C. can be used).
5.7 0.7 mm thick sample mounting steel (e.g., galvanized or stainless steel) sheet plate.
5.8 T&GT 8020 support fixture with horizontal sliding sample assembly.
5.9 Data Acquisition system to record temperatures at a minimum of 2 Hz.

### 6. Equipment Setup

6.1 Move the T&GT fixture (includes the torch, hand held media blast gun with regulator), the oxygen and hydrogen gas bottles into the a fire test chamber.
6.2 Install proper regulators, flashback arrestors and hoses to each prospective gas bottle. Connect appropriate gas hoses to the torch.
6.3 Verify thermocouple (TC) locations as follows: (e.g., see FIGS. 5 & 6)
   6.3.1 Type B, 1″ from torch face directly in flame ring.
   6.3.2 Type K, 1″ from torch face offset to the outside of the torch flame ring.
   6.3.3 Type K, located on the steel sheet plate as close as possible to the center of the torch flame.
   6.3.4 Alternatively, all of the thermocouples can be Type K.
6.4 Connect thermocouples to a digital acquisition (DAQ) system. The system consists of programming logic and memory (i.e., computer with controller and user interface) to gather and store acquired data.
6.5 Verify sample distance is about 1.75″ to the torch face for test method 1). See FIG. 5. Alternatively, for test method 2) verify that the steel sheet plate distance to torch face is about 2.5″ which will put the average thickness sample approximately about 2.375″ to the torch face.
6.6 Check abrasive level and fill media blast gun if required.
6.7 Move electric timer/solenoid assembly unit into location.
6.8 Connect an air line from a source of compressed air to the inlet of the electric timer solenoid.
6.9 Connect an air line from the outlet of the electric timer solenoid to the regulator on the handheld media blast gun.
6.10 Verify and/or set media blast regulator to desired pressure (i.e., 172.4 kPa (25 psi)).

### 7. Test Procedure

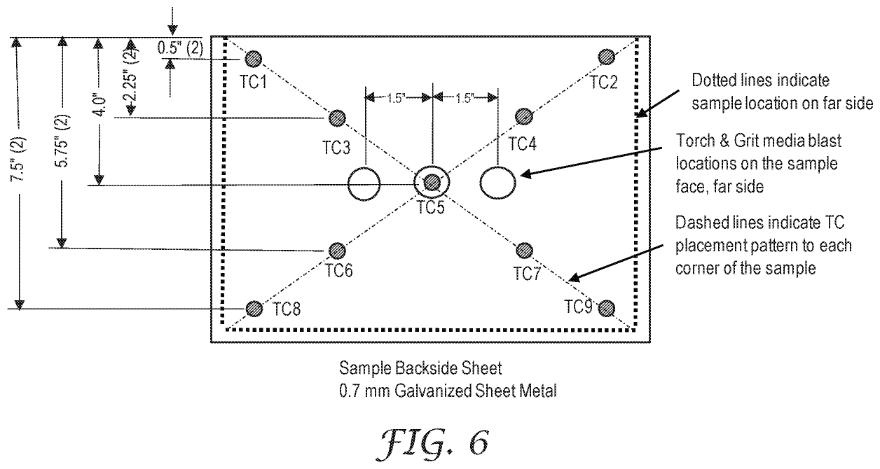

7.1 Open T&GT test log and record required sample information.
7.2 Samples can be pre mounted to the steel sheet plate as shown in FIG. 6, for example, with the sample being centered on the two mounting screws and held at the top of the sample.
7.3 Take a picture of the sample prior to mounting or while mounted. Should have ID information written on the face to be shown in the picture.
7.4 Place the sample and backing sheet plate in the horizontal sliding sample assembly and connect to the DAQ.
7.5 Start DAQ and ensure thermocouples are connected and working properly.
7.6 Check abrasive level and fill media blast gun if required.
7.7 Slowly open Hydrogen and Oxygen bottle regulator valves until pressure is registered on the regulator valve gauges. Valves should NOT be opened more than one full turn.
7.8 Check line pressure values for both hydrogen (5 psi max) and oxygen (10 psi max) gases. Adjust if necessary, do not exceed maximums shown above.
7.9 Open hydrogen flow valve on the torch ½ turn and ignite torch flame.
7.10 Open oxygen flow valve ½ turn and quickly turn the hydrogen flow valve back to slightly less than ¼ turn.
7.11 Check to ensure hydrogen pressure is set to 3 psi and the oxygen pressure is set to 5 psi on their respective line pressure gages.

### Alternative Torch and Grit Process A (Test Method 2)

7.12 Using the hydrogen flow vale on the torch, adjust flame temperature to 1200° C.+/−15-20° C. measured by the Type K thermocouple directly in front of the torch face.
7.13 Once required temperature has been obtained and is stable, slide the sample to the 1^{st} torch & grit media blast location and hold for 5 seconds.
7.14 After the 5 second hold start media blasts cycles by pressing the start button on the electric timer assembly.
   7.14.1 Target number of media blast cycles is 3.
   7.14.2 A cycle consists of 5 seconds of torch flame exposure followed by 10 seconds of a media blast and then 5 more seconds of torch only exposure for a total cycle time of 20 seconds.
   7.14.3 After each 20 second cycle the sample is to be moved horizontally 38.1 mm (1.5″) following the pattern shown in FIG. 6.

### Alternative Torch and Grit Process B (Test Method 1)

7.15 Adjust flame to an approximate temperature of 1150° C. measured by the type B thermocouple.
7.16 Insert sample and monitor temperature using the type B thermocouple if above 1300° C. or a type K thermocouple if below 1300° C. Target temperature is 1200° C.+/−15-50° C., readjust hydrogen flow valve (valve on torch) to obtain required temperature. Use caution so overtemperature of sample does not occur.
7.17 Once required temperature has been obtained and is stable, move the Type B thermocouple up in the fixture to remove it from media blast exposure if measuring temperature with the type B thermocouple. If measuring with a type k thermocouple, it can be left in location during media blasts.
7.18 Start media blasts cycles by pressing the start button on the electric timer assembly.
   7.18.1 Target number of media blast cycles is 12.
   7.18.2 A cycle consists of 10 seconds of media blast time and 5 seconds on non-media blast time for a total cycle time of 15 seconds.
   During media blasts the temperature can decrease in the range of approximately 200° C.-400° C. due to air pressure volume cooling the hydrogen torch. Higher temperature drops may be seen with higher pressure media blasts.

### Alternative Torch and Grit Process A (Test Method 2)

7.19 After 3 torch & grit media blast cycles are complete, ramp temperature down to approximately 650° C. at the last media blast location and hold for 10 minutes.
7.20 Test is complete.

### Alternative Torch and Grit Process B (Test Method 1)

7.21 Completion of test will be determined as follows:
   7.21.1 Material burns and/or deteriorates after initial flame exposure.
   7.21.2 A hole is burned through the sample to the steel sheet back plate.
   7.21.3 Completion of 12 media blast cycles without seeing a hole burn through sample material.
   7.21.4 For test method 2, three media blasts followed by 10 minute 650° C. temperature hold on last media blast location.
7.22 At test completion allow time for sample to cool
7.23 Once cooled, remove the sample from the sheet plate, take picture of the front and back of the sample and place in properly marked plastic bag (Sample ID, date and test data file time stamp).
7.24 Make any required notes regarding the test in the test log

TABLE 3
Test Methods and Results

| | Nail-Penetration Test | | | | Tensile (No Heat | | | | |
|---|---|---|---|---|---|---|---|---|---|
| | | Heat | Sandblast Test | | Treatment) | | | Torch | Torch |
| | | Transmission | No Heat | Heat | Warp | Weft | Flame | Flame | Flame |
| | | Factor | Treatment | Treated | Direction | Direction | Test | Test A | Test B |
| | Pass | (%) | (s) | (s) | (N/5 cm) | (N/5 cm) | Pass | Pass | Pass |
| EX1 | Yes | 20 | 101 | 39 | 3000 | 1900 | Yes | DNT | DNT |
| EX2 | Yes | 19 | 124 | 25 | 2700 | 1700 | Yes | DNT | DNT |
| EX3 | Yes | 38 | 124 | 25 | 2700 | 1700 | Yes | DNT | DNT |
| EX4 | Yes | DNT | DNT | DNT | 4200 | 3200 | DNT | Yes | Yes |
| EX5 | Yes | DNT | DNT | DNT | 4800 | 3300 | DNT | Yes | No |
| EX6 | Yes | DNT | DNT | DNT | 4700 | 3700 | DNT | Yes | Yes |
| CE1 | No | 50 | 2 | 1 | DNT | DNT | Yes | DNT | DNT |

DNT-Did Not Test

While Example 5 survived the lower temperature Torch Flame Test A, it did not survive the higher temperature Torch Flame Test B. However, it was unexpected that adding an additional fabric layer so that the fabric layer was on both sides of the inorganic based paper layer (CEQUIN) allowed the Example 6 laminate to pass the much higher temperature Torch Flame B test.

Due to the wide variety of battery cells, battery module and battery cell pack designs, materials with a wide variety of performance properties could be applicable depending on how they are incorporated in the design.

TABLE 4
Materials

| Designation | Description | Source |
|---|---|---|
| 2327 | Colloidal silica 20 nm, | Nalco Company (an |
| | available under the trade | Ecolab Company), |
| | designation NALCO 2327 | Naperville, IL, USA |
| POLYPLATE | Kaolin clay available | KaMin LLC, Macon, |
| P | under the trade designation | GA. USA |
| | POLYPLATE P | |

### Example 7

A core layer (137 mm×152 mm) of thin polycrystalline ceramic nonwoven needled mat assembled according to Example 1 in commonly owned U.S. Patent Publication 2020/0002861(de Rovere et al) was coated with a supplementary layer of inorganic paste made of 46 wt % 2327 and 54 wt % POLYPLATE P assembled according to Example 1 in commonly owned PCT Publication No. WO2013/044012 (Dietz). The mat with coating was dried at 110° C. in a batch oven. The coating was applied to one surface and did not penetrate through the entire thickness of the mat. The basis weight of the mat was 442 gsm, the dry basis weight of the inorganic coating was 2651 gsm, and the total basis weight of the final composite was 3093 gsm. The thickness of the composite was 4.2 mm. The density of the composite was calculated to be 0.736 g/cc (density=basis weight/thickness). The sample underwent T&GT at 344.7 kPa (50 psi) and no failure was noted after 120 seconds (12 cycles times 10 second blasts).

### Example 8

A core layer (152 mm×152 mm) of BONDO 499 mat (3M Company) was heat cleaned at 600° C. for five minutes and coated with a supplementary layer of inorganic paste made of 46 wt % 2327 and 54 wt % POLYPLATE P assembled according to Example 1 in commonly owned PCT Publication No. WO2013/044012 (Dietz). The mat with coating was dried at 115° C. in a batch oven. The coating was pushed through the thickness of the mat to coat as much fiber as possible. The bottom side had less inorganic paste content than the top side. Prior to drying, a layer of silica fiber cloth (300 gsm) (where was this obtained) was applied to the surface of the coating to limit the formation of cracking lines on the surface of the coating during drying. The silica cloth was removed after drying. The basis weight of the chopped glass fiber strand mat was 268 gsm, the dry basis weight of the inorganic paste was 2606 gsm, and the composite basis weight was 2874 gsm. The thickness of the composite was 1.97 mm. The density of the composite was calculated to be 1.458 g/cc. The sample then underwent T&GT at 344.7 kPa (50 psi) and no failure was noted after 120 seconds (12 cycles times 10 second blasts).

### Examples 9-30 (EX9-EX30)

Assembled samples were 203 mm×203 mm (8 inch×8 inch) unless otherwise noted.

TABLE 5
Fabric Materials

| | Fabric | | |
|---|---|---|---|
| Desig- | Number | | |
| nation | (#) | Description | Source |
| e-Glass | 1 | 3.2 mm (0.125 inch) | McMaster Carr, |
| Tape 1 | | thick glass tape, | Elmhurst, IL, |
| | | 1661 gsm | USA |
| e-Glass | 2 | 1.6 mm (0.063 inch) | McMaster Carr |
| Tape 2 | | thick glass tape, | |
| | | 860 gsm | |
| e-Glass | 3 | 4H satin weave, | JPS Composite |
| Weave 1 | | style 332, 427 gsm | Materials, |
| | | | Anderson, SC, |
| | | | USA |
| e-Glass | 4 | Woven roving, 18 oz, | Composite |
| Weave 2 | | 610 gsm | Envisions LLC, |
| | | | Wausau, |
| | | | WI, USA |
| e-Glass | 5 | Plain weave, 18 oz, | Composite |
| Weave 3 | | 610 gsm | Envisions LLC |
| e-Glass | 6 | 3310G fiberglass | Mineral Seal |
| Weave 4 | | cloth, 18 oz, 0.8 mm | Corporation, |
| | | (1/32 inch) | Tucson, AZ, |
| | | | USA |
| e-Glass | 7 | #8817K68 | McMaster Carr |
| Weave 5 | | | |
| Glass Yarn | 8 | Knit heat treated | 3M Company |
| Casting | | glass yam casting tape | |
| Tape | | available under the | |
| | | trade designation | |
| | | SCOTCHCAST | |
| Silica | 9 | Heat treated yam silica | Intec, Anaheim, |
| Weave | | weaver available under | CA, USA |
| | | the designation TECSIL, | |
| | | 76.2 mm (3 inch) | |

TABLE 6
Binder Materials

| Designation | Description | Source |
|---|---|---|
| 569 | Alumina cement available | Aremco Products |
| | under the trade designation | Inc, Valley Cottage, |
| | CERAMABON 569 | NY, USA |
| 2327 | Colloidal silica 20 nm, | Nalco Company |
| | available under the trade | |
| | designation NALCO 2327 | |
| N | Liquid sodium silicate | PQ Corporation, |
| | available under the | Malvern, PA, USA |
| | designation N | |

TABLE 7
Filler & Additive Materials

| Designation | Description | Source |
|---|---|---|
| HG90 | Kaolin clay available | KaMin LLC |
| | under the trade | |
| | designation HG90 | |
| J12MS | Surface treated HPMC | Dupont |
| | thickener available | Corporation, |
| | under the trade | Wilmington, |
| | designation | DE, USA |
| | METHOCEL J12MS | |
| M5 | Fumed silica available | Cabot |
| | under the designation | Corporation, |
| | CAB-O-SIL M-5 | Boston, MA, |
| | | USA |
| POLYPLATE | Kaolin clay available | KaMin LLC |
| P | under the trade | |
| | designation | |
| | POLYPLATE P | |
| R900 | Titanium dioxide | Dupont |
| | | Corporation, |
| | | Wilmington, |
| | | DE, USA |

Slurries were prepared using ingredients shown in Tables 5, 6, and 7 by procedures described in commonly owned PCT Publication No. WO2013/044012 (Dietz). In each slurry, inorganic materials were added to liquid component(s) using a high shear mixer to form a given slurry as represented in Table 8 below.

TABLE 8
Slurry Compositions

| Slurry | |
|---|---|
| Number (#) | Composition |
| 1 | 45 wt % 2327 and 55 wt % POLYPLATE P |
| 2 | 44 wt % 2327, 15 wt % R900, 15 wt % |
| | HG90, and 26 wt % POLYPLATE P |
| 3 | 71 wt % N and 29 wt % HG 90 |
| 4 | 100 wt % 569 |
| 5 | Slurry 1 and 1.8% M5 |
| 6 | 49.8% 2327, 25% R900, 25% HG90, and |
| | 0.2% J12MS |

Each fabric sample was then impregnated with a given slurry and subsequently dried via a drying/heat treatment procedure as shown in Table 9 below. After drying, the sample was heat treated at specific temperatures with a latex coating (VINNAPAS EAF 68 obtained from Wacker Chemie AG of Munich, Germany or 26172 obtained from Lubrizol of Wickliffe, Ohio, USA under the trade designation HYCAR 26172) to increase the strength of the thermal barrier article. In some examples, the samples were not treated with a latex coating (i.e., no coating). Each sample underwent T&GT and the results are shown in Table 9. In Table 9, (x #) indicates that the layer was stacked on itself where x is 2 or 3 times.

TABLE 9
Test Samples and Results

| | | | Basis | | | | Heat | |
|---|---|---|---|---|---|---|---|---|
| | Slurry | Fabric | weight | Temperature | Pressure | Blasts | treat | Latex |
| | # | # | gsm | ° C. | kPa | Survived | ° C. | coating |
| EX9 | 4 | 5 | 3100 | 1200 | 172.4 | 12 | 170 | No |
| EX10 | 3 | 5 | 2080 | 1200 | 172.4 | 3 | 20 | No |
| EX11 | 5 | 5 | 2970 | 1200 | 172.4 | 8 | 170 | EAF68 |
| EX12 | 2 | 5 | 2350 | 1200 | 172.4 | 12 | 170 | EAF68 |
| EX13 | 2 | 3 | 1490 | 1200 | 172.4 | 6 | 170 | EAF68 |
| EX14 | 6 | 5 | 1728 | 1200 | 172.4 | 10 | 170 | 26172 |
| EX15 | 2 | 4 | 1540 | 1200 | 172.4 | 5 | 170 | EAF68 |
| EX16 | 2 | 4 | 1740 | 1200 | 172.4 | 3 | 170 | EAF68 |
| EX17 | 2 | 4 | 1807 | 1200 | 172.4 | 12 | 600 | 26172 |
| EX18 | 2 | 5 | 1979 | 1200 | 172.4 | 12 | 170 | 26172 |
| EX19 | 2 | 5 | 1982 | 1200 | 172.4 | 12 | 600 | 26172 |
| EX20 | 2 | 6 | 2280 | 1200 | 172.4 | 12 | 170 | 26172 |
| EX21 | 2 | 6 | 2215 | 1200 | 172.4 | 12 | 500 | 26172 |
| EX22 | 1 | 1 | 5300 | 1200 | 172.4 | 12 | 170 | EAF68 |
| EX23 | 1 | 2 | 2600 | 1200 | 172.4 | 12 | 170 | EAF68 |
| EX24 | 1 | 2 | 2600 | 1200 | 344.7 | 12 | 170 | EAF68 |
| EX25 | 2 | 9 | 3900 | 1200 | 344.7 | 4 | 170 | No |
| EX26 | 2 | 9 | 3350 | 1200 | 344.7 | 2 | 170 | No |
| EX27 | 1 (×3) | 8 | 4175 | 1200 | 344.7 | 10 | 150 | No |
| EX28 | 1 (×3) | 8 | 3830 | 1200 | 344.7 | 12 | 400 | No |
| EX29 | 1 (×2) | 8 | 2550 | 1200 | 344.7 | 12 | 400 | No |
| EX30 | 1 (×2) | 8 | 2550 | 1200 | 517.1 | 12 | 400 | No |

### Example 31

A core layer of BASOTECT W (BASF) was laminated with a supplementary layer of 0.51 mm, 540 gsm CEQUIN (3M Company) and 0.44 mm, 430 gsm TG430 fabric (obtained from HKO Isolier-und Textiltechnik GmBH of Oberhausen, Germany). The thickness of the barrier article was between about 5.8 mm and 6.0 mm. The sample underwent CGTBT and the temperature recorded on the cold side was XX° C. The sample size was 203 mm×254 mm (8 inch×10 inch). The sample then underwent T&GT at 172.4 kPa (25 psi) and no failure was noted at each of the three target locations after a 10 second active blast time.

### Example 32

A core layer of BASOTECT W (BASF) was laminated with a supplementary layer of an e-Glass 1 coated with an inorganic paste made of 44 wt % 2327 and 26 wt % POLYPLATE P, 15 wt % HG90 Clay, and 15 wt % R900 assembled according to Example 1 in commonly owned PCT Publication No. WO2013/044012 (Dietz). The thickness of the composite was between about 5.8 and 6.3 mm. The sample size was 203 mm×254 mm (8 inch×10 inch). The sample then underwent T&GT at 172.4 kPa (25 psi) and no failure was noted at each of the three target locations after a 10 second active blast time.

### Comparative Example 2

A 2.0 mm thick, 4000 gsm make/model mica board sample obtained from Cogebi of Dover, N.H., USA (the density was calculated to be 2.0 g/cc underwent CGTBT and the temperature recorded on the cold side was 421° C. The sample then underwent T&GT procedure at 172.4 kPa (25 psi) and a hole perforated through the board during the seventh blast.

### Comparative Example 3

A 0.8 mm thick make/model mica board sample obtained from Cogebi (the density was calculated to be 2.0 g/cc underwent T&GT procedure at 172.4 kPa (25 psi) and a hole perforated through the board during the second blast.

### Comparative Example 4

A 0.8 mm thick make/model mica board sample obtained from Cogebi (the density was calculated to be 2.0 g/cc underwent T&GT procedure at 344.7 kPa (25 psi) and a hole perforated through the board during the first blast.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A thermal barrier article comprising:
a core layer containing a plurality of fibers or a flame-retardant foam; and
a supplementary layer disposed on or integrated within the core layer,
wherein the thermal barrier article is operatively adapted to survive or withstand at least one cycle of the Torch and Grit Test.

2. The thermal barrier article of claim 1, wherein the plurality of fibers comprises polycrystalline ceramic fibers, E-glass fibers, R-glass fibers, ECR-glass fibers, basalt fibers, or silicate fibers.

3. The thermal barrier article of claim 1, wherein the flame-retardant foam comprises melamine or polyurethane.

4. The thermal barrier article of claim 1, wherein the supplementary layer comprises an inorganic binder coating containing inorganic particles.

5. The thermal barrier article of claim 1, wherein the thermal barrier article has a thickness in the range of from about 0.5 mm to about 10.0 mm.

6. A battery compartment of an electric vehicle comprising at least one battery cell or assembly at least partially enclosed by the thermal barrier article of claim 1.

7. A method of arresting or at least slowing down the occurrence of a thermal runaway event in an electric vehicle battery assembly, with the method comprising:
at least partially enclosing at least one battery cell of an electric vehicle battery assembly with the thermal barrier article of claim 1.

8. A method of evaluating whether a thermal barrier article can arrest or at least slow down the occurrence of a thermal runaway event in an electric vehicle battery assembly, where the method includes performing at least one cycle comprising:
subjecting an exposed face of the thermal barrier article to an elevated temperature in the range of from about 600° C. up to about 1800° C. for at least 5 seconds, and
while the exposed face is still subjected to the elevated temperature, subjecting the exposed face to a blasting of metal oxide particle media having a size in the range of from about 60 to about 200 grit for at least 10 seconds, where the particle media is being discharged at a pressure in the range of from about 25 to about 50 psi.

9. The method of claim 8, wherein the exposed face is positioned about 44.5 mm (1.75 inches) from the source of the temperature, from the source of the discharged particle media, or both.

10. The method of claim 1, wherein each cycle also comprises subjecting an exposed face of the thermal barrier article to a temperature in the range of from about 600° C. up to about 1800° C. for at least 5 seconds, after the blasting.

11. The method of claim 1, wherein the method comprises performing in the range of 1 to 12 cycles.

12. The method of claim 1, wherein each cycle is performed at multiple locations across the exposed face.

13. The method of claim 1, wherein only one cycle is performed at multiple locations across the exposed face.

14. The method of claim 1, wherein each cycle is performed only at a central location on the exposed face.

15. The method of claim 1, wherein only one cycle is performed only at a central location on the exposed face.
